(19) United States
(12) Patent Application Publication
(10) Pub. No.: US 2012/0141153 A1
(43) Pub. Date: Jun. 7, 2012

(54) IMAGE FORMING APPARATUS

(75) Inventors: Takahiro NOZAKI, Nagoya (JP); Takuya YAMAGUCHI, Toyokawa (JP); Masahito HAMAYA, Nagoya (JP)

(73) Assignee: BROTHER KOGYO KABUSHIKI KAISHA, Nagoya (JP)

(21) Appl. No.: 13/313,332

(22) Filed: Dec. 7, 2011

(30) Foreign Application Priority Data
Dec. 7, 2010 (JP) 2010-272953

(51) Int. Cl. G03G 15/043

(52) U.S. Cl. 399/51

(57) ABSTRACT

An image forming apparatus is provided, which includes a main body housing that includes an opening formed at an upper side thereof and supports a plurality of photoconductive bodies, a cover that is disposed above the main body and configured to open and close the opening, an exposure unit that is provided to the cover and configured to expose the photoconductive bodies, an image data processor configured to store and process input image data, an exposure unit controller configured to control the exposure unit based on the image data processed by the image data processor, a first circuit board including the image data processor formed thereon, and a second circuit board including the exposure unit controller formed thereon. The first circuit board and the second circuit board are attached to the cover.

### CROSS-REFERENCE TO RELATED APPLICATION

This application claims priority under 35 U.S.C. §119 from Japanese Patent Application No. 2010-272953 filed on Dec. 7, 2010. The entire subject matter of the application is incorporated herein by reference.

### BACKGROUND

1. Technical Field

The following description relates to one or more image forming apparatuses including an image data processor for processing image data and an exposure unit controller for controlling an exposure unit.

2. Related Art

An image forming apparatus (such as a printer) has generally been known, which includes an image data processor configured to convert image data received from an external device such as a personal computer into image data that the image forming apparatus is allowed to process, and an exposure unit controller configured to control an exposure unit of the image forming apparatus based on the image data processed by the image data processor.

As an example of the image forming apparatus, an apparatus has been known that includes a circuit board (an LED control board) with an exposure unit controller formed thereon. The circuit board is fixed to an upper cover provided with an exposure unit (an LED unit). In this case, it is possible to connect the exposure unit controller with the exposure unit via a short cable. Thereby, for instance, it is possible to prevent image quality of a resulting image from being deteriorated due to noises transmitted through the cable.

### SUMMARY

In the known image forming apparatus, since the circuit board with the image data processor formed thereon is fixed to a main body housing of the image forming apparatus, the image data processor fixed to the main body housing needs to be connected with the exposure unit controller fixed to the upper cover via a long cable. Therefore, there is still remaining such a risk that the image quality might be deteriorated due to noises transmitted through the long cable. To resolve the problem, it is possible to use a cable having a high shield effect to shield against extraneous noises. However, such a cable having a high shield effect is expensive, and it results in an increasing cost of the whole apparatus.

Aspects of the present invention are advantageous to provide one or more improved techniques for an image forming apparatus that make it possible to prevent image quality of a formed image from being deteriorated, by rendering shorter a cable for connecting an image data processor with an exposure unit controller.

According to aspects of the present invention, an image forming apparatus is provided, which includes a main body housing including an opening formed at an upper side thereof, the main body housing supporting a plurality of photoconductive bodies, a cover disposed above the main body housing, the cover being configured to open and close the opening of the main body housing, an exposure unit provided to the cover, the exposure unit being configured to expose the plurality of photoconductive bodies, an image data processor configured to store and process input image data, an exposure unit controller configured to control the exposure unit based on the image data processed by the image data processor, a first circuit board including the image data processor formed thereon, and a second circuit board including the exposure unit controller formed thereon. The first circuit board and the second circuit board are attached to the cover.

### BRIEF DESCRIPTION OF THE ACCOMPANYING DRAWINGS

FIG. 1 is a cross-sectional side view showing an overall configuration of a color printer in an embodiment according to one or more aspects of the present invention.

FIG. 2 is a cross-sectional side view showing the color printer in a state where an upper cover is open in the embodiment according to one or more aspects of the present invention.

FIG. 3 schematically shows a layout of circuit boards and a wiring structure in the color printer in the embodiment according to one or more aspects of the present invention.

FIG. 4A is an enlarged cross-sectional view schematically showing an upper front side of the upper cover in a state where a discharge stopper is in a folded position in the embodiment according to one or more aspects of the present invention.

FIG. 4B is an enlarged cross-sectional view schematically showing the upper front side of the upper cover in a state where the discharge stopper is in a usage position in the embodiment according to one or more aspects of the present invention.

FIG. 4C is an enlarged cross-sectional view schematically showing the upper front side of the upper cover in a state where the discharge stopper is in the usage position and an inner cover is open in the embodiment according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

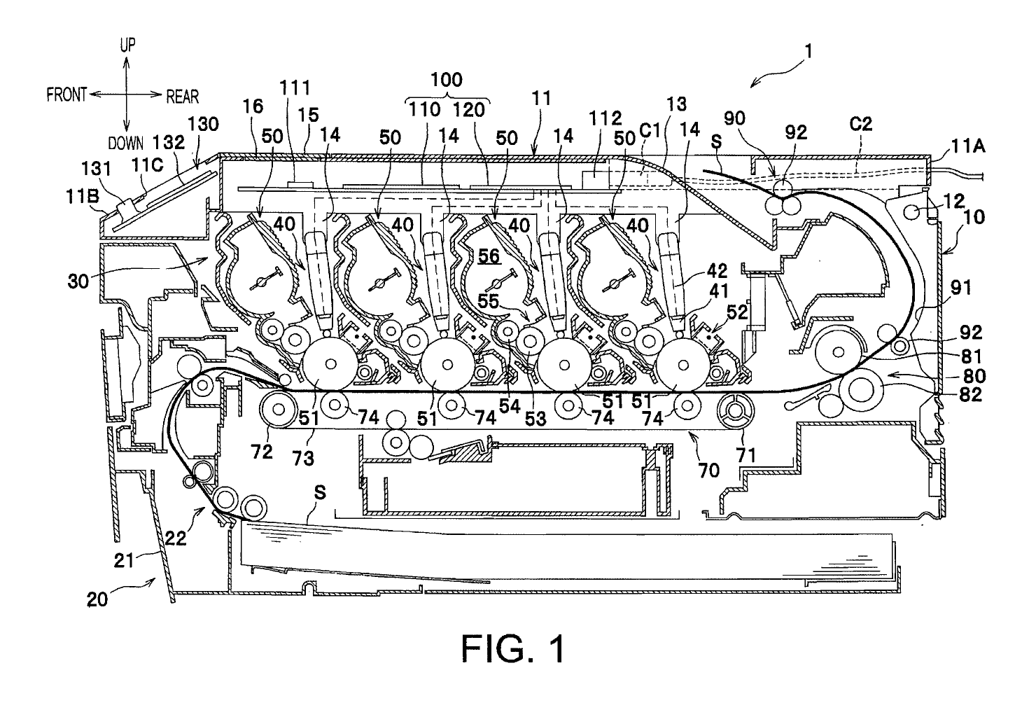

Hereinafter, an embodiment according to aspects of the present invention will be described with reference to the accompanying drawings. It is noted that, in the following description, a front-to-rear direction and an up-to-down direction with respect to a color printer 1 of the embodiment will be defined as shown in the accompanying drawings, respectively. Further, in FIG. 1, a near side and a far side in a direction perpendicular to the sheet will be defined as a “right” side and a “left” side, respectively.

<Overall Configuration of Color Printer>

As shown in FIG. 1, the color printer 1 includes a main body housing 10, an upper cover 11, a sheet feeding unit 20 configured to feed a sheet S, an image forming unit 30 configured to form an image on the sheet S fed by the sheet feeding unit 20, and a discharge unit 90 configured to discharge the sheet S with the image formed thereon.

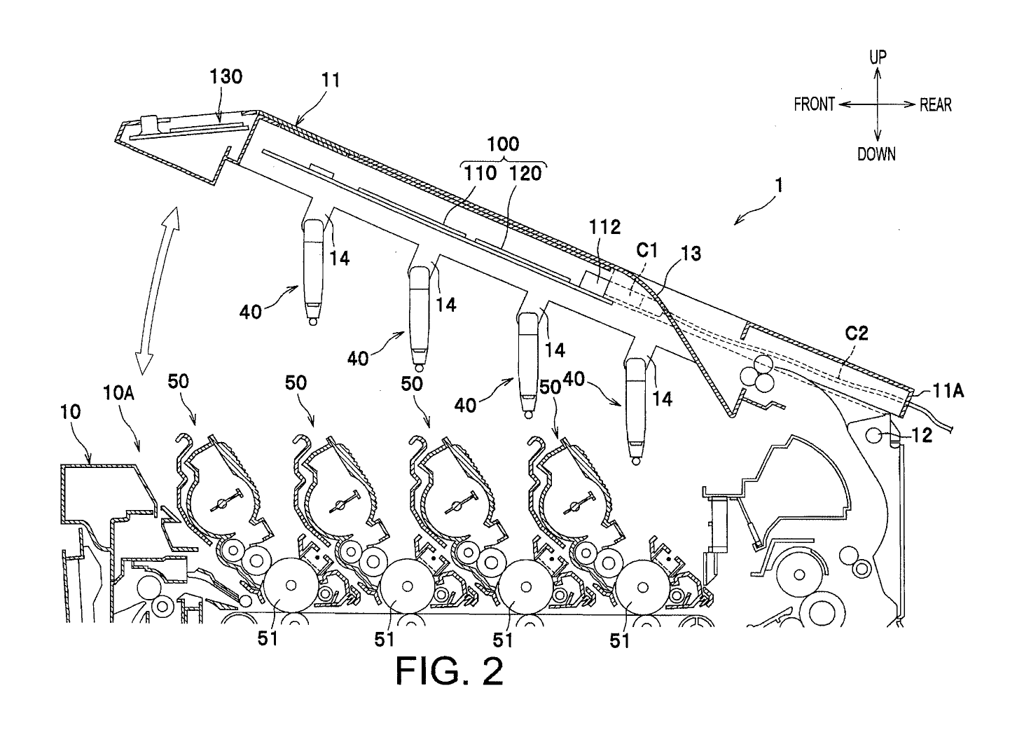

The upper cover 11 is disposed above the main body housing 10. As shown in FIG. 2, the upper cover 11 is configured to open and close an opening 10A formed at an upper face (an upper side) of the main body housing 10. More specifically, the upper cover 11 is configured to open and close the opening 10A of the main body housing 10 when a front side of the upper cover 11 turns up and down relative to the main body housing 10 around a rotational shaft 12 disposed at a rear end of the main body housing 10. On an upper surface of the upper cover 11, a discharge tray 13 is disposed such that the sheet S discharged from the inside of the main body housing 10 is placed thereon. A lower surface of the upper cover 11 is provided with four holding portions 14 for holding below-mentioned LED units 40.

Referring back to FIG. 1, the sheet feeding unit 20 is disposed at a lower side of the main body housing 10. The sheet feeding unit 20 includes a feed tray 21 that accommodates the sheets S, and a sheet supply mechanism 22 configured to supply the sheets S from the feed tray 21 to the image forming unit 30. The sheet supply mechanism 22 picks up the sheets S in the feed tray 21 on a sheet-by-sheet basis to sequentially feed each picked-up sheet S to the image forming unit 30.

The image forming unit 30 includes four LED units 40, four process units 50, a transfer unit 70, and a fixing unit 80.

The LED units 40 are provided on a lower side of the upper cover 11. Each LED unit 40 includes a head portion 41 and a supporting portion 42 that supports the head portion 41.

The head portion 41 extends along an axial direction (the left-to-right direction) of a photoconductive drum 51. When the upper cover 11 is closed, a lower end of the head portion 41 is disposed to face an upper surface of the photoconductive drum 51. The head portion 41 has a plurality of light emitting elements (LEDs) arranged in the left-to-right direction at a distal end thereof. Each LED is turned on and off in response to an input signal from a below-mentioned LED controller 120, so as to expose the charged photoconductive drum 51.

The supporting portion 42 is a member for holding the head portion 41 supported by the upper cover 11. Specifically, a lower section of the supporting portion 42 supports the head portion 41, and an upper section of the supporting portion 42 is attached to the upper cover 11 via the holding portion 14. Thereby, the LED unit 40 is rendered away from the photoconductive drum 51 when the upper cover 11 is opened (see FIG. 2).

The process units 50 are arranged in parallel along the front-to-rear direction, between the upper cover 11 and the feed tray 21. Each process unit 50 is detachably attached to the main body housing 10 through the opening 10A, which is exposed when the upper cover 11 is opened. Each process unit 50 includes the photoconductive drum 51, an electrification device 52, a development roller 53, a supply roller 54, a layer thickness regulating blade 55, and a toner tank 56. When each process unit 50 is attached to the main body housing 10, the main body housing 10 supports the hour photoconductive drums 51 arranged in parallel along the front-to-rear direction.

The transfer unit 70 is disposed between the feed tray 21 and the process units 50. The transfer unit 70 includes a driving roller 71, a driven roller 72, an endless conveying belt 73 wound around the pair of the driving roller 71 and the driven roller 72, and four transfer rollers 74. The conveying belt 73 is disposed to be pinched between each transfer roller 74 and a corresponding one of the photoconductive drums 51, such that an outer surface thereof contacts each photoconductive drum 51.

The fixing unit 80 is disposed behind the process units 50 and the transfer unit 70. The fixing unit 80 includes a heating roller 81 and a pressing roller that is disposed to face and press the heating roller 81.

In the image forming unit 30, when a surface of the rotating photoconductive drum 51 is exposed by the LED unit 40 after evenly charged by the electrification device 52, an electrostatic latent image based on image data is formed on the photoconductive drum 51. Further, toner in the toner tank 56 is supplied onto the development roller 53 via the supply roller 54, and carried on the development roller 53 as a thin layer with a constant thickness regulated by the layer thickness regulating blade 55.

Then, when the toner carried on the development roller 53 is supplied onto the photoconductive drum 51, the electrostatic latent image is visualized and a toner image is formed on the photoconductive drum 51. After that, when the sheet S fed by the sheet feeding unit 20 is conveyed through between the photoconductive drums 51 and the conveying belt 73 (the transfer rollers 74), the toner image formed on each photoconductive drum 51 is sequentially transferred onto the sheet S in a superimposed manner. When the sheet S with the toner images transferred thereon is conveyed through between the heating roller 81 and the pressing roller 82, the toner images are thermally fixed.

The discharge unit 90 includes a discharge path 91 for guiding the sheet S fed by the fixing unit 80, and a plurality of feed rollers 92 for feeding the sheet S. The sheet S with the toner images thermally fixed thereon is conveyed on the discharge path 91 by the feed rollers 92, discharged out of the main body housing 10, and put on the discharge tray 13.

<Detailed Configuration of Color Printer>

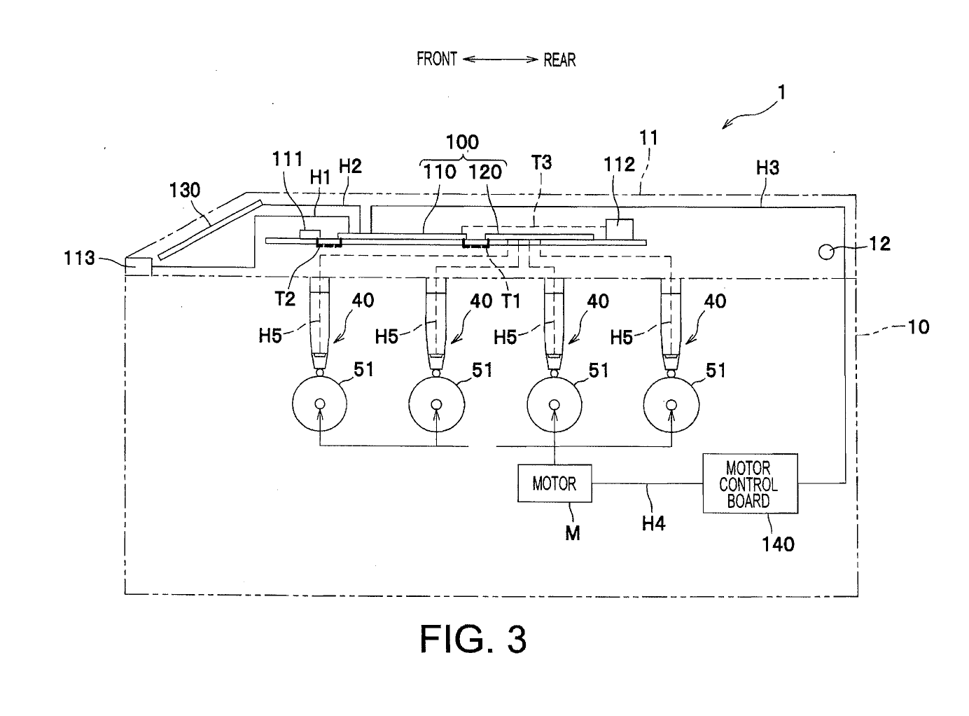

Subsequently, a detailed configuration of the color printer 1 will be described. As shown in FIG. 3, the color printer 1 includes a main board 100, an operation panel control board 130, a motor control board 140, and a motor M.

The main board 100 is a printed-circuit board on which an image data processor 110 and an LED controller 120 are formed. In other words, in the embodiment, a circuit board with the image data processor 110 formed thereon and a circuit board with the LED controller 120 formed thereon are integrated as a single circuit board (i.e., the main board 100).

The main board 100 (the circuit board with the image data processor 110 formed thereon and the circuit board with the LED controller 120 formed thereon) is disposed in a space between the upper surface (the discharge tray 13) and the lower surface (the holding portions 14) of the upper cover 11, i.e., inside the upper cover 11. Further, the main board 100 is fixed to the upper cover 11.

The image data processor 110 is configured to store and process image data received from an external device such as a personal computer. More specifically, the image data processor 110 stores and extracts compressed image data received from an external device, and converts the image data into image data of a predetermined format (e.g., bitmap data) with which the color printer 1 complies. Thereafter, the image data processor 110 transmits the processed image data to the LED controller 120.

Further, the image data processor 110 outputs, to the motor control board 140, timing information (a signal) for driving the motor M based on an image forming instruction, which is transmitted by the external device along with the image data. Thus, the image data processor 110 controls a sheet feeding system (such as the sheet supply mechanism 22 and the feed rollers 92) and the image forming unit 30 via the motor control board 140.

To perform the aforementioned processes, the image data processor 110 includes a CPU (not shown) configured to execute arithmetic processing, a ROM (not shown) configured to store various programs and setting values, and a RAM (not shown) configured to store the image data. Additionally, the image data processor 110 (the main board 100) includes a memory socket 111 and a connector 112 that is an interface through which the image data is received from the external device.

The memory socket 111 is a socket configured such that an expansion memory (not shown) such as a DIMM and a SIMM is detachably attached thereto. Thereby, it is possible to add or replace an expansion memory. The memory socket 111 is provided on the main board 100 (on which the image data processor 110 is formed). The memory socket 111 is connected with the image data processor 110 via a cable (wire) T2 formed on the main board 100.

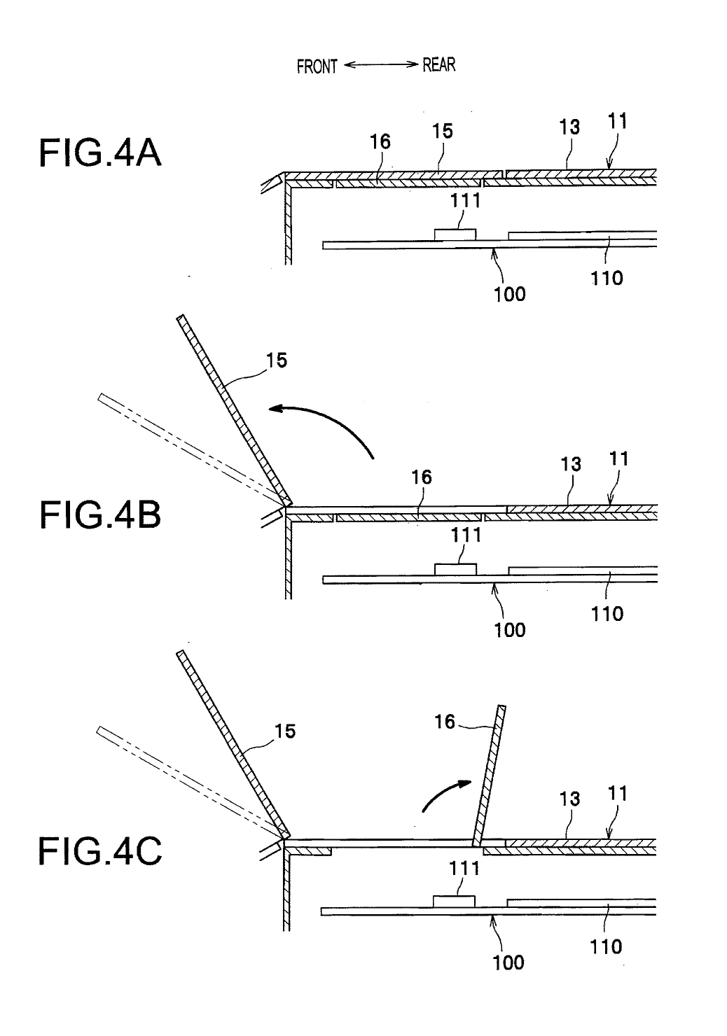

As shown in FIG. 4A, a portion, of the upper surface (the discharge tray 13) of the upper cover 11, which portion corresponds to an upper side of the memory socket 111 is provided with a discharge stopper 15 and an inner cover 16.

The discharge stopper 15 is rotatable relative to the upper cover 11 around a downstream side (a front side) thereof in a discharge direction in which the sheet S with the image formed thereof is discharged out of the main body housing 10. The discharge stopper 15 is rotatable between a folded position (see FIG. 4A) where the discharge stopper 15 is substantially in plane with the upper surface of the discharge tray 13 and a usage position (see FIG. 4B) where the discharge stopper 15 is rotated by a predetermined angle from the unset position.

As shown in FIG. 4B, when being in the usage position, the discharge stopper 15 contacts a leading end of the sheet S (not shown in FIG. 4B) discharged out of the main body housing 10 so as to restrict movement of (the leading end of) the sheet S. Thereby, it is possible to true up the leading ends of two or more sheets S and to prevent the sheets S from dropping out of the discharge tray 13.

As shown in FIG. 4A, the inner cover 16 is disposed beneath the discharge stopper 15 in the folded position. Further, as shown in FIG. 4C, when the discharge stopper 15 is in the usage position, the inner cover 16 is rotatable relative to the upper cover 11 around an upstream side (a rear end) thereof in the discharge direction of the sheet S, in a rotational direction opposite to the rotational direction of the discharge stopper 15.

As shown in FIG. 4A, the inner cover 16 is shrouded in the discharge stopper 15 in the folded position. Further, as shown in FIG. 4B, when the discharge stopper 15 is rotated into the usage position, the inner cover 16 is exposed outside. Moreover, as shown in FIG. 4C, when the inner cover 16 is opened, the memory socket 111 on the main board 100 is exposed.

According to the upper cover 11 configured as above, in the embodiment, a user is allowed to easily add or replace an expansion memory (such as a DIMM and a SIMM) from the front side of the color printer 1. Further, since the inner cover 16 is provided, even when the discharge stopper 15 is used, it is possible to prevent dust particles from coming into the upper cover 11.

Referring back to FIG. 3, the connector 112 is a female connector configured to be connected with the external device that inputs a print job (including the image forming instruction and the image data) into the image data processor 110. The connector 112 is fixed to the main board 100 (on which the image data processor 110 is foamed). The connector 112 is connected with the image data processor 110 via a cable (wire) T3 formed on the main board 100. It is noted that, in FIG. 3, the cable T3 is indicated by a dashed line running above the main board 100 for the sake of illustrative convenience.

As shown in FIG. 1, the connector 112 is provided in a state where a connector surface (a rear surface) thereof is exposed outside. The connector 112 is connected with an external device (not shown) such as a personal computer via a male connector C1 and a cable C2. Examples of the connector 112 include a USB connector, a LAN connector, and a parallel connector.

In the embodiment, the connector 112 is disposed to face rearward. The cable C2, connected with the connector 112, is drawn rearward out of a rear end surface 11 A of the upper cover 11.

Compared with the front side of the upper cover 11, the rear side of the upper cover 11, where the rotational shaft 12 is provided, does not move relatively so much when the upper cover 11 is opened. Therefore, when the cable C2 is drawn out of the rear end of the upper cover 11, it leads to a small displacement of the cable C2 when the upper cover 11 is opened. Thereby, it is possible to prevent the cable C2 (the male connector C1) from being disconnected from the connector 112 when the upper cover 11 is opened or closed.

As shown in FIG. 3, the upper cover 11 includes a USB connector 113. The USB connector 113 is a female connector configured to be connected with a USB memory (not shown). The USB connector 113 is disposed at the front side of the upper cover 11 and connected with the image data processor 110 via a cable (wire) H1. The color printer 1 of the embodiment is configured to perform image formation based on image data stored on the USB memory, which is connected with the USB connector 113.

Thus, since the upper cover 11 includes the USB connector 113, the user is allowed to attach and detach the USB memory in a more comfortable position than when the USB connector 113 is provided at the main body housing 10. Further, in the embodiment, the main board 100 (on which the image data processor 110 is formed) is fixed to the upper cover 11. Therefore, it is possible to render shorter the cable H1 for connecting the image data processor 110 with the USB connector 113 than a cable employed in such a known configuration that a circuit board with an image data processor formed thereon is fixed to a main body housing.

The LED controller 120 is configured to take on/off control of the light emitting elements (the LEDs) while transmitting signals to each LED unit 40 (each head portion 41) based on the image data processed by the image data processor 110. The LED controller 120 and the image data processor 110 are connected with each other via a cable (wire) T1 formed on the main board 100.

The operation panel control board 130 is a circuit board on which an operation panel controller (not shown) configured to accept a user operation is formed. The operation panel control board 130 is fixed to the front side of the upper cover 11. As shown in FIG. 1, the operation panel control board 130 includes a plurality of operation buttons 131 (one of them is only shown in FIG. 1) and a liquid crystal display (LCD) panel 132. Each operation button 131 is configured such that an upper end thereof protrudes from a front panel 11B of the upper cover 11. Thereby, each operation button 131 is allowed to accept a user operation. Further, the LCD panel 132 is visually recognized through a window 11C formed at the front panel 11B of the upper cover 11.

As shown in FIG. 3, the operation panel control board 130 is connected with the image data processor 110 via a cable (wire) H2. The operation panel control board 130 is configured to transmit to the image data processor 110 an instruction that the user inputs by operating the operation buttons 131. In addition, the operation panel control board 130 displays on the LCD panel 132 information such as input data and a status of the color printer 1.

In the embodiment, the main board 100 (on which the image data processor 110 is formed) is fixed to the upper cover 11. Therefore, it is possible to render shorter the cable H2 for connecting the image data processor 110 with the operation panel controller than a cable employed in such a known configuration that a circuit board with an image data processor formed thereon is fixed to a main body housing.

The motor M is disposed in an appropriate position inside the main body housing 10. The motor M is configured to drive the sheet feeding system (including the sheet supply mechanism 22 and the feed rollers 92) and the image forming unit 30 (including the photoconductive drums 51, the development rollers 53, the supply rollers 54, the transfer rollers 74, and the pressing roller 82).

The motor control board 140 is a circuit board on which a motor controller (not shown) configured to take control for driving the motor M is formed. In the embodiment, the motor control board 140 is fixed, in a vertically standing manner, to a left side of the rear end of the main body housing 10. The motor control board 140 (the motor controller) is connected with the image data processor 110 via a cable (wire) H3. The motor control board 140 is configured to take control for driving the sheet feeding system and the image forming unit 30 by controlling an on/off action, a rotational speed, and a rotational direction of the motor M based on the timing information for driving the motor M that is received from the image data processor 110.

In the embodiment, the motor control board 140 (on which the motor controller is formed) is fixed to the main body housing 10 in which the motor M is disposed. Therefore, it is possible to render shorter the cable H4 for connecting the motor M with the motor controller and to simplify a wiring structure in the main body housing 10.

According to the color printer 1 configured as above in the embodiment, the circuit board with the image data processor 110 formed thereon and the circuit board with the LED controller 120 formed thereon are fixed to the upper cover 11. Hence, it is possible to place the image data processor 110 and the LED controller 120 close to each other. Thereby, it is possible to shorten the cable T1 for connecting the image data processor 110 with the LED controller 120, and thus to prevent the quality of a formed image from being deteriorated due to noises transmitted through the cable T1 for connecting the image data processor 110 with the LED controller 120.

Especially, in the embodiment, the circuit board with the image data processor 110 formed thereon and the circuit board with the LED controller 120 formed thereon are integrated as a single circuit board (i.e., the main board 100). Therefore, it is possible to place the image data processor 110 and the LED controller 120 as close to each other as practicable, and thus to render the cable T1 as short as practicable. Consequently, it is possible to more certainly prevent the quality of the formed image from being deteriorated due to noises transmitted through the cable T1.

Further, the image data processor 110 is disposed in the upper cover 11 provided above the main body housing 10. Thereby, it is possible to make exposed the memory socket 111 that is an interface for the image data processor 110 by opening the inner cover 16 which is disposed at the upper surface of the upper cover 11, and thus to achieve an easy access to the memory socket 111 to add or replace an expansion memory.

Further, in the embodiment, the inner cover 16 is disposed under the discharge stopper 15 in the folded position. Hence, compared with such a configuration that the inner cover 16 is disposed separately from the discharge stopper 15, the upper cover 11 has fewer discontinuities (gaps) on the surface thereof. Thus, it is possible to make better the appearance of the color printer 1.

Since the operation panel control board 130 is fixed to the upper cover 11, it is possible to shorten the cable H2 for connection the image data processor 110 with the operation panel controller. Additionally, since the upper cover 11 includes the USB connector 113, it is possible to shorten the cable H1 for connecting the image data processor 110 and the USB connector 113. Further, since the connector 112 is provided on the main board 100, it is possible to shorten the cable T3 for connecting the image data processor 110 and the connector 112.

According to the color printer 1 configured as above, it is possible to make smaller a space required for wiring in the whole apparatus (including the main body housing 10 and the upper cover 11). Thus, it is possible to enhance flexibility for a layout of the other parts and components and to downsize the color printer 1.

Further, since the connector 112 is disposed on the main board 100, it is possible to attach, to the upper cover 11, the connector 112 together with the main board 100. Thus, it is possible to simplify a process of assembling the color printer 1.

The color printer 1 includes the four LED units 40, each of which includes the head portion 41 disposed to face the photoconductive drum 51. Therefore, for instance, compared with such a configuration that a single laser scanner (which is configured to perform high-speed scanning on a photoconductive body with a laser beam to expose the photoconductive body) is disposed above the process units 50, there are a larger number of cables H5 for connecting the LED controller 120 with the head portions 41.

Therefore, the color printer 1 is more likely to be affected by noises than the configuration with single laser scanner. However, in the embodiment, the cable T1 for connecting the image data processor 110 with the LED controller 120 is allowed to be shortened. Thus, it is possible to alleviate the influence of noises on the color printer 1 as a whole. Namely, aspects of the present invention are effective particularly in such a configuration that the plurality of head portions 41 are disposed to face the respective photoconductive drums 51 as exemplified in the embodiment.

Further, in the embodiment, the main board 100 on which the LED controller 120 is formed is fixed to the upper cover 11 that includes the LED units 40 (the head portions 41). Therefore, the cables H5 for connecting the LED controller 120 with the head portions 41 are allowed to be shortened. Thereby, it is possible to alleviate the influence of noises on the cables H5.

It is noted for confirmation that, in the color printer 1, the main board 100 on which the image data processor 110 is fixed to the upper cover 11, and the motor control board 140 is fixed to the main body housing 10. Therefore, the cable H3 for connecting the image data processor 110 with the motor control board 140 (the motor controller) needs to be long. However, even though the cable H3 has some noises therein, the influence of the noises in the cable H3 on the image quality is negligibly small in comparison with the cable T1 for connecting the image data processor 110 with the LED controller 120 and the cables H5 for connecting the LED controller 120 with head portions 41.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein. For example, the following modifications are feasible.

<Modifications>

In the aforementioned embodiment, the circuit board with the image data processor 110 formed thereon and the circuit board with the LED controller 120 formed thereon are integrated as a single circuit board (i.e., the main board 100). However, for instance, a circuit board (a main board) with the image data processor 110 formed thereon may be provided separately from a circuit board with the LED controller 120 formed thereon.

The discharge stopper 15 exemplified in the aforementioned embodiment, which discharge stopper is configured to restrict movement of the leading end of the sheet S discharged out of the main body housing 10, may be replaced with an extension tray as indicated by a chain double-dashed line in FIGS. 4B and 4C. The extension tray may be rotatable by a larger rotational angle from the folded position (see FIG. 4A) to the usage position (see FIG. 4B) than the rotational angle of the discharge stopper 15. The extension tray may be configured to support the leading end of the sheet S from beneath in the usage position, so as to prevent the sheet S, which has its longitudinal direction along the discharge direction, from dropping out of the discharge tray 13.

In the aforementioned embodiment, the inner cover 16 is disposed under the discharge stopper 15 in the folded position and exposed outside when the discharge stopper 15 is in the usage position. However, the inner cover 16 may be provided at the upper surface of the upper cover 11 so as to be directly exposed outside.

In the aforementioned embodiment, the inner cover 16 is configured to rotate relative to the upper cover 11 around the rear end thereof so as to be open and closed. However, the inner cover 16 may be configured to slide relative to the upper cover 11.

The USB memory, exemplified as an external storage medium in the aforementioned embodiment, may be replaced with any of other storage devices such as SmartMedia (trademark registered), CompactFlash (trademark registered), Memory Stick (trademark registered), SD Memory Card (trademark registered), and a hard disk drive. Further, the USB connector 113 may be replaced with an appropriate connector conforming to an applied external storage device. Furthermore, the color printer 1 (as an image forming apparatus) may include a plurality of connectors to accept a plurality of kinds of external storage devices.

In the aforementioned embodiment, the USB connector 113 is provided separately from the main board 100 (on which the image data processor 110 is formed). However, for instance, the USB connector 113 may be disposed on (fixed to) the main board 100 on which the image data processor 110 is formed.

In the aforementioned embodiment, the DIMM and the SIMM are exemplified as an expansion memory. However, any kind of storage device (memory) may be employed as an expansion memory as far as it is configured to be replaced and added to the circuit board on which an image data processor is formed and to be used as a main memory in the same manner as the DIMM and the SIMM. In this case, an appropriate memory connector may be employed in conformity with the kind of the expansion memory.

In the aforementioned embodiment, the connector 112 is provided (fixed) to the main board 100 (on which the image data processor 110 is formed). However, for example, the connector 112 may be provided separately from the main board 100 with the image data processor 110 formed thereon.

In the aforementioned embodiment, the LAN (connector) is exemplified as an interface for receiving external image data. The LAN may be a wired LAN or a wireless LAN.

In the aforementioned embodiment, the operation panel control board 130 with the operation panel controller formed thereon is exemplified as being provided with the plurality of operation buttons 131 and the LCD panel 132. However, for instance, the operation panel control board 130 may be provided with a touch panel instead of the plurality of operation buttons 131 and the LCD panel 132. Further, the operation panel control board 130 with the operation panel controller formed thereon may be connected with an operation board, provided separately from the operation panel control board 130, which operation board may include operation buttons and an LCD panel or include a touch panel.

In the aforementioned embodiment, the operation panel controller is provided separately from the main board 100 on which the image data processor 110 is formed. However, for instance, the image data processor 110 and the operation panel controller may be formed on the same board. In other words, the main board 100 with the image data processor 110 formed thereon may have a functional element for accepting user operations.

In the aforementioned embodiment, the main board 100 and the operation panel control board 130 are fixed to the upper cover 11, and the motor control board 140 is fixed to the main body housing 10. However, for instance, all the circuit boards, such as the main board 100, the operation panel control board 130, and the motor control board 140, may be fixed to the upper cover 11.

In the aforementioned embodiment, the motor controller is provided separately from the main board 100 on which the image data processor 110 is formed. However, for instance, the image data processor 110 and the motor controller nay be formed on the same circuit board. In other words, the main board 100 with the image data processor 110 formed thereon may have a functional element for taking control to drive the motor M.

In the aforementioned embodiment, the LED units 40 are exemplified as exposure units. However, for instance, each head portion 41 may include electroluminescence elements or fluorescent substances in place of the LEDs. Additionally, each head portion 41 may include optical shutters (such as liquid crystal elements and PLZT elements) arranged at a light emitting end of a backlight such as a fluorescent lamp and an LED. Further, the LED units 40 may be replaced with a laser scanner.

In the aforementioned embodiment, the upper cover 11 is provided to be rotatable (openable and closable) relative to the main body housing 10 around the rotational shaft 12. However, for instance, the upper cover 11 may be configured to vertically translate to open and close the opening 10A of the main body housing 10.

In the aforementioned embodiment, aspects of the present invention are applied to the color printer 1 exemplified as an image forming apparatus. However, for instance, aspects of the present invention may be applied to a copy machine or a multi-function peripheral that includes a document reader such as a flatbed scanner. When aspects of the present invention are applied to an image forming apparatus including a document reader, a circuit board with an image data processor formed thereon may have a functional element for controlling the document reader.

In the aforementioned embodiment, the sheet S such as a regular paper and a heavy paper is exemplified as a recording sheet. However, for instance, an OHP sheet (transparency) may be employed as a recording sheet.

What is claimed is:

1. An image forming apparatus comprising:
a main body housing comprising an opening formed at an upper side thereof, the main body housing supporting a plurality of photoconductive bodies;
a cover disposed above the main body housing, the cover being configured to open and close the opening of the main body housing;
an exposure unit provided to the cover, the exposure unit being configured to expose the plurality of photoconductive bodies;
an image data processor configured to store and process input image data;
an exposure unit controller configured to control the exposure unit based on the image data processed by the image data processor;
a first circuit board comprising the image data processor formed thereon; and
a second circuit board comprising the exposure unit controller formed thereon,
wherein the first circuit board and the second circuit board are attached to the cover.

2. The image forming apparatus according to claim 1,
wherein the plurality of photoconductive bodies are arranged in parallel, and
wherein the exposure unit comprises a plurality of exposure heads each of which is disposed to face one of the photoconductive bodies when the cover closes the opening.

3. The image forming apparatus according to claim 1,
wherein the first circuit board comprises a memory attachment portion configured such that an expansion memory is detachably attached thereto, and
wherein the cover comprises an openable and closable member that is disposed at an upper side thereof and configured to make the memory attachment portion exposed when open.

4. The image forming apparatus according to claim 3,
wherein the cover comprises a plate member configured to rotate between:
a first position where the plate member is substantially in plane with a discharge surface onto which a sheet with an image formed thereon is discharged out of the main body housing; and
a second position where the plate member is rotated by a predetermined angle from the first position, and
wherein the openable and closable member is disposed under the plate member in the first position.

5. The image forming apparatus according to claim 1, comprising:
a motor that is provided to the main body housing and configured to drive the photoconductive bodies; and
a third circuit board having a function to take control to drive the motor, the third circuit board being attached to the main body housing.

6. The image forming apparatus according to claim 1, comprising a fourth circuit board having a function to accept a user operation, the fourth circuit being attached to the cover.

7. The image forming apparatus according to claim 1,
wherein the cover comprises an external storage connector configured to be connected with an external storage device.

8. The image forming apparatus according to claim 1,
wherein the first circuit board and the second circuit board are integrated as a single circuit board.

9. The image forming apparatus according to claim 1,
wherein the first circuit board comprises an external device connector configured to be connected with an external device that issues an image forming instruction to the image data processor.
